(19) United States
(12) Patent Application Publication
(10) Pub. No.: US 2022/0036376 A1
(43) Pub. Date: Feb. 3, 2022

(54) METHODS AND SYSTEMS FOR SUGGESTING ALTERNATIVE PHRASES FOR TEXT-BASED WEB CONTENT

(71) Applicant: SHOPIFY INC., Ottawa (CA)

(72) Inventor: ERIC WICHMAN, York (CA)

(21) Appl. No.: 16/943,051

(22) Filed: Jul. 30, 2020

(51) Int. Cl. G06Q 30/02; G06F 16/9535; G06F 16/9538; G06F 16/9532; G06Q 30/06; G06N 5/04; G06F 40/289; G06F 40/166; G06F 40/14

(52) U.S. Cl. CPC G06Q 30/0201; G06F 16/9535; G06F 16/9538; G06F 16/9532; G06F 40/14; G06N 5/04; G06F 40/289; G06F 40/166; G06Q 30/0625

(57) ABSTRACT

A merchant may generate web content relating to a product offered for sale by the merchant. A product may be described in a variety of different ways. A merchant might not be able to determine which language used to describe the product, including the specific words, tone, phrases, etc., may result in a favourable outcome for their online store, e.g. in terms of increasing traffic and/or product sales. In some embodiments, there is provided a computer-implemented system and method that suggests one or more alternative phrases for a piece of text-based content on a merchant's webpage relating to a product for sale, and that presents the one or more alternative phrase suggestions to the merchant.

### FIELD

The present application relates to natural language processing, and, more particularly, to determining alternative phrase suggestions for text-based web content and providing the phrase suggestions on a user interface.

### BACKGROUND

A merchant may use a commerce platform to sell products to customers. The commerce platform will be referred to herein as an e-commerce platform. The products for sale by the merchant may be sold online via an online store. A merchant may generate web content relating to a product offered for sale by the merchant within their online store. The web content related to the product may include text-based content, such as a product webpage that describes the product and/or a blog post that discusses the product, etc.

A product may be described in a variety of different ways, which may include the use of different phrases with varying level of detail. For example, a merchant selling a dog collar that emits light may describe this product on the merchant's product webpage as a “glow collar for dogs”. Alternatively, the merchant may describe the product as a “light-up safety collar for dogs” or a “pet night collar”, etc.

The language used to describe the product may result in varying levels of interest from online consumers.

### SUMMARY

A merchant might not be able to determine which language used to describe a product, including the specific words, tone, phrases, etc., may result in favourable outcomes for their online store, e.g. in terms of increasing traffic and/or product sales.

In some embodiments, it is desired to have a computer-implemented system that suggests one or more alternative phrases for a piece of text-based content on a merchant's webpage relating to a product for sale, and that presents the one or more alternative phrase suggestions to the merchant.

However, the computer-implemented system is faced with the technical challenge of how to determine alternative phrases that are relevant, possibly in real-time (or near real-time), e.g. as the merchant is generating text content for a webpage.

Embodiments are described below in which the computer-implemented system determines one or more alternative phrases for a particular phrase used by a merchant in their web content describing a product. In some embodiments, each alternative phrase is obtained based on the system searching for a phrase that is both: (i) an alternative to the particular phrase used by the merchant (e.g. shares common keywords with the particular phrase used by the merchant), and (ii) is associated with another product for which a particular event has occurred that has a favourable outcome (e.g. the phrase is used to describe another product on the e-commerce platform that has a high sales conversion rate).

In some embodiments, alternative phrases are provided to the merchant in real-time (or near real-time) while the merchant is generating a new webpage relating to a product for sale in their online store. In some embodiments, alternative phrase suggestions are provided for one or more products in the merchant's product catalog. In some embodiments, text-based content may be automatically replaced. In some embodiments, scores are assigned to the alternative phrases based on their similarity to the original text-based content and/or based on the particular event each alternative phase is associated with. In some embodiments, split testing is performed for a specified duration of time to compare the outcome of two or more suggested alternative phrases for a piece of text-based content on a webpage relating to a product for sale.

In one embodiment, a computer-implemented method includes obtaining web content for a webpage, where the web content includes a first phrase describing a first product. The method may further include identifying a second phrase that has an association with a second product for which a particular event has occurred. The method may further include determining that the second phrase is an alternative to the first phrase, and may also include transmitting the second phrase for display on a device. A system is also disclosed that is configured to perform the methods disclosed herein. For example, the system may include a memory to store information and at least one processor to directly perform (or instruct the system to perform) the method steps. A computer-readable medium is also disclosed herein having computer-executable instructions stored thereon that, when executed by a computer, cause the computer to perform the method steps.

Note that a phrase, as used herein, may encompass several words or only one word. Also, a phrase may alternatively be referred to as a string.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 is an example of a home page of an administrator, according to one embodiment;

FIG. 3 illustrates the e-commerce platform of FIG. 1, but with a search engine, memory to store a phrase library, and a phrase suggestion engine;

FIG. 4 illustrates a system for determining alternative phrases for text-based content on a merchant's webpage, according to one embodiment;

FIG. 5 illustrates steps of providing alternative phrase suggestions to a merchant for a piece of text-based content, according to some embodiments;

FIG. 6 illustrates an example product webpage generation interface for an e-commerce platform;

FIG. 7 illustrates an example product webpage generation interface for an e-commerce platform, where the phrase suggestion engine provides the alternative phrase suggestions;

FIG. 8 illustrates an example product webpage;

FIG. 9 illustrates an example phrase library that may be associated with the phrase suggestion engine;

FIG. 10 illustrates the example product webpage generation interface of FIGS. 6 and 7, where an additional interface is provided to the merchant to implement split testing;

FIG. 11 illustrates an example product catalog in an e-commerce platform;

FIG. 12 illustrates the product catalog of FIG. 11 and the options presented to the merchant when selecting to employ the phrase suggestion engine;

FIG. 13 illustrates the example product catalog of FIGS. 11 and 12, where the alternative phrase suggestions are presented to the merchant to optionally select;

FIG. 14 illustrates the example product catalog if FIGs., 11 and 12, where the phrase suggestion engine has automatically replaced phrases with alternative phrase suggestions; and

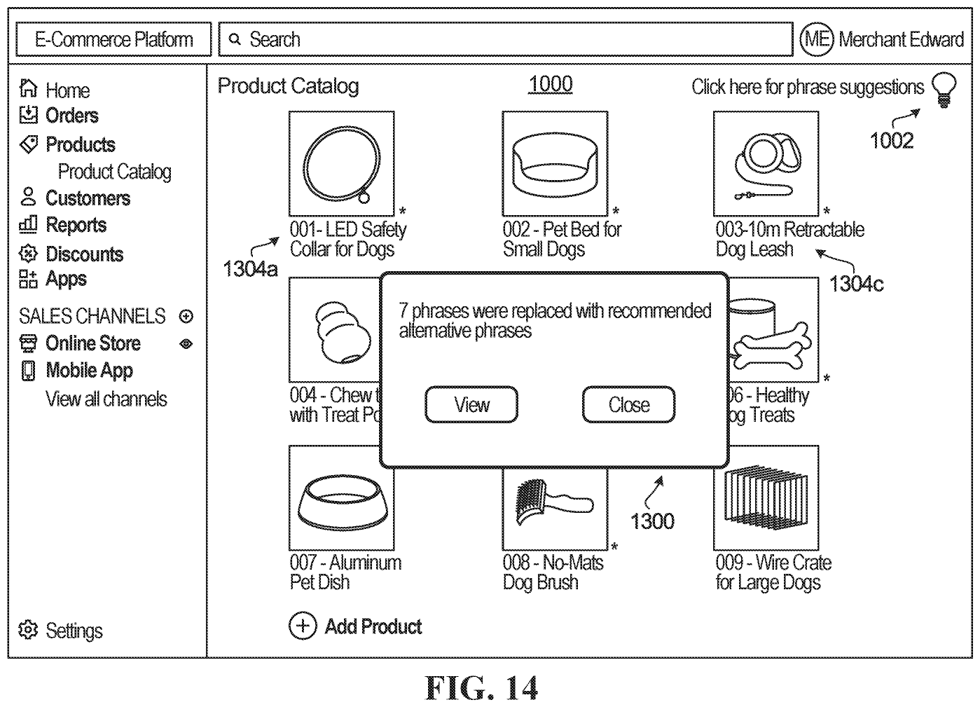

FIG. 15 illustrates steps of a computer-implemented method, according to one embodiment.

### DETAILED DESCRIPTION

For illustrative purposes, specific example embodiments will now be explained in greater detail below in conjunction with the figures.

### Example E-Commerce Platform

A merchant may use an e-commerce platform to sell products to customers, and the e-commerce platform may include text-based web content that, when rendered on a web page, is used to describe a product. Because the methods disclosed herein may be performed in relation to an e-commerce platform, an example of an e-commerce platform will be described.

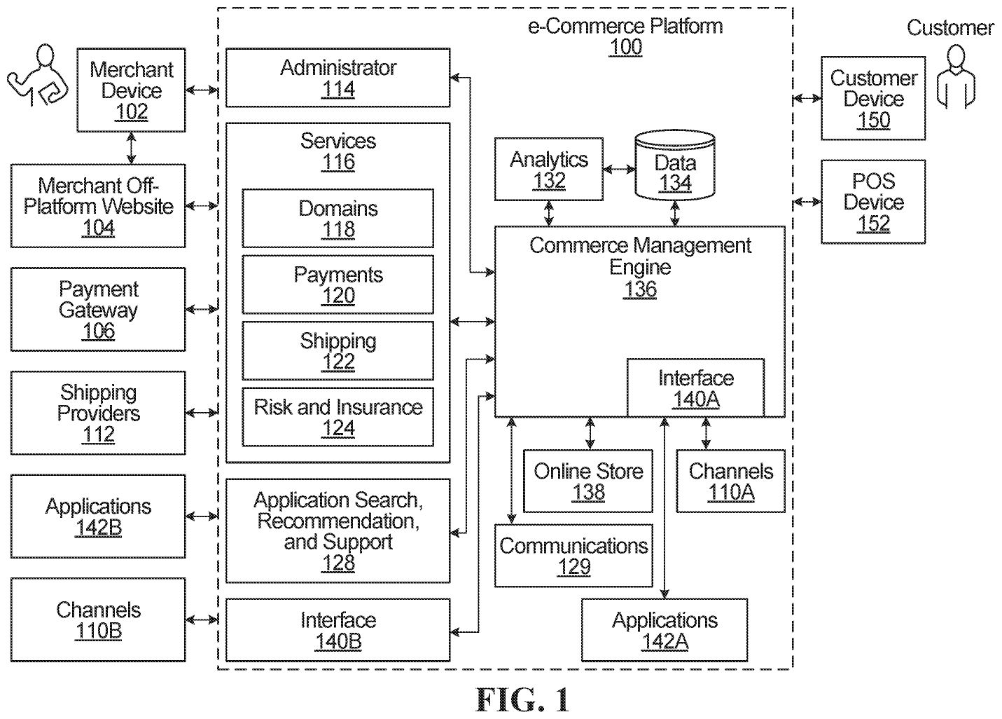

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. AR references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or an individual merchant's storefront (e.g., a merchant's online store)

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, I-ITML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author bldg posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

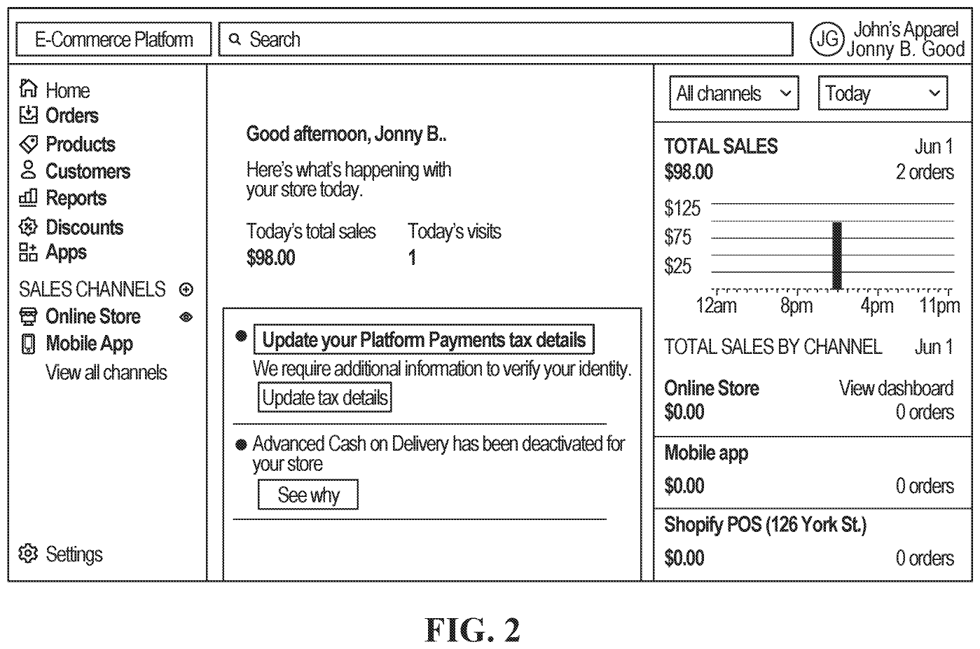

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 100A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfil led, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, PUS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 14213 may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform l.00 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 1 10A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and. green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10” off products X, Y, and Z.

Customers then pay for the content of their cart resulting in the creation of an order -for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent -to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Determining Alternative Phrases for Text-Based Content in the E-Commerce Platform 100

A merchant having a merchant account on the e-commerce platform 100 may generate text-based web content relating to a product offered for sale by the merchant. However, as described earlier, a product may be described in a variety of ways, and the merchant might not be able to determine which language may result in a more favourable outcome, e.g. in terms of increasing traffic and/or product sales. In some embodiments, the e-commerce platform 100 determines one or more alternative phrases for the text-based content that may instead be used to describe the product. In some embodiments, the alternative phrases may be determined within the e-commerce platform 100 using the commerce management engine 136. The text-based product-related content and the alternative phrases determined may be presented to the merchant using a user interface on their merchant device 102.

The text-based content may be any text on a -webpage relating to a product for sale within a merchant's online store 138. For example, the text-based content may include at least one of: a product title, a product description, a header on a webpage, a text banner, an image capture, webpage metadata, etc.

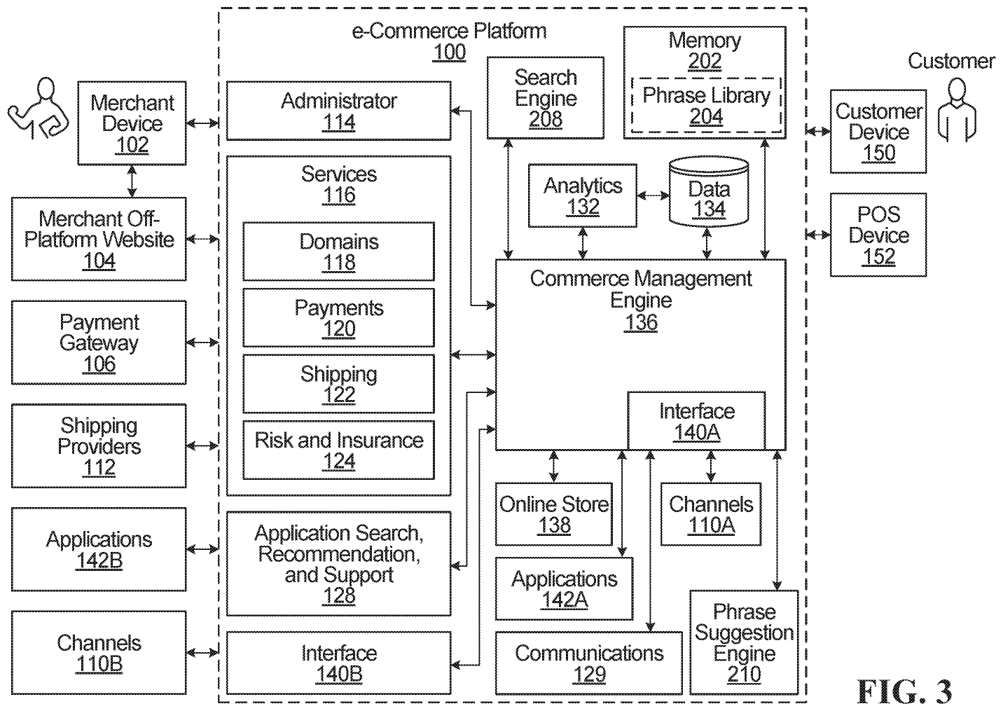

FIG. 3 illustrates the e-commerce platform 100 of FIG. 1, but with the additions of a memory 202, a search engine 208, and a phrase suggestion engine 210. All of these additional components may be part of and/or in two-way communication with the commerce management engine 136. The phrase suggestion engine 210 performs the phrase suggestion methods disclosed herein. For example, the phrase suggestion engine 210 may determine whether a phrase associated with a particular product found using the search engine 208 is an alternative to a phrase describing a product in the merchant's online store 138. The phrase suggestion engine 210 may be implemented by one or more general-purpose processors that execute instructions stored in a memory (e.g. in the memory 202) or stored in another non-transitory computer-readable medium. The instructions, when executed, cause the phrase suggestion engine 210 to perform operations relating to the suggestion of alternate phrases for text-based content. Alternatively, some or all of the processor of the phrase suggestion engine 210 may be implemented using dedicated circuitry, such as an application specific integrated circuit (ASK), a graphics processing unit (GPU), or a programmed field programmable gate array (FPGA). Similarly, the search engine 208 may be implemented by a processor that may be implemented by one or more general-purpose processors that execute instructions stored in a memory (e.g. in the memory 202) or stored in another non-transitory computer-readable medium. The instructions, when executed, cause the search engine 208 to perform the search engine methods disclosed herein. Alternatively, some or all of the processor of the search engine 208 may be implemented using dedicated circuitry', such as an ASIC, a GPU, or a programmed FPGA. In some embodiments, one or more of the search engine 208, phrase suggestion engine 210, and memory 202 may be located externally to the e-commerce platform 100.

In some embodiments, the phrase suggestion engine 210 within the e-commerce platform 100 is used to implement the process of analyzing one or more selected pieces of text-based content and determining alternative phrases related to the text-based content, e.g. in the manner described later. An alternative phrase determined by the phrase suggestion engine 210 may be associated with a product similar to the product described by the selected text-based content, and that similar product may also be associated with a particular event that has occurred in relation to the similar product. The particular event is typically an event that is correlated with a favourable outcome in relation to the product; for example, the particular event may be a sales conversion rate exceeding a predefined threshold.

For example, a first merchant may generate a product webpage for a light-emitting dog collar offered for sale in their online store 138. The first merchant enters the product title for the light-emitting dog collar as “Glow collar for dogs”. In an embodiment, the phrase suggestion engine 210 may determine that the phrase “LED safety collar for dogs” is an alternative product description phrase associated with a related product sold by a second merchant on the e-commerce platform 100, for which a particular event has occurred (e.g. high sales conversion rate). The phrase suggestion engine 210 suggests that the first merchant instead use the alternative product title “LED safety collar for dogs”.

Alternative phrases for the text-based content may include similar phrases found in search queries. The search queries may be returned to the commerce management engine 136 through the search engine 208 and later stored within the data 134 related to each product.

The memory 202 linked with the commerce management engine 136 may include a phrase library 204. Each phrase in the phrase library 204 may be associated with a respective product in the data 134 of the commerce management engine 136. The phrase library 204 in the memory 202 may be established and maintained in non-real time and may provide stored alternative phrase suggestions to the merchant.

Although the embodiments described below may be implemented using phrase suggestion engine 210, search engine 208, and memory 202 in e-commerce platform 100, the embodiments described below are not limited to the specific e-commerce platform 100 of FIGS. 1 to 3, and the embodiments may be implemented using any e-commerce platform. More generally, the embodiments below are not necessarily limited to an e-commerce platform, but may be fully (or partly) implemented on other web-based platforms, e.g. a platform for writing blogs. Therefore, the embodiments below will be described more generally in relation to any text-based web content relating to a product offered for sale by a merchant.

### Example System for Suggesting Alternative Phrases

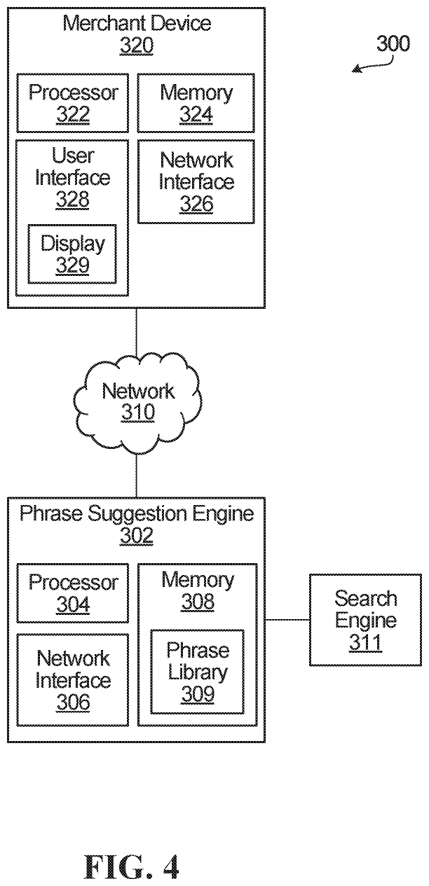

FIG. 4 illustrates a system for determining alternative phrases for text-based content relating to products offered for sale by a merchant, according to one embodiment. The system 300 includes a search engine 311 and a phrase suggestion engine 302 in communication with a merchant device 320 via a network 310.

The phrase suggestion engine 302 may be a part of an e-commerce platform, e.g. e-commerce platform 100. For example, the phrase suggestion engine 302 may be implemented by a processor on the e-commerce platform 100 of FIG. 3. The phrase suggestion engine 302 could also or instead be provided by another component of an e-commerce platform or implemented as a stand-alone component or service that is external to an e-commerce platform. In some embodiments, the phrase suggestion engine 302 may be provided in the form of a downloadable application that is available for installation in relation to a merchant account. In addition, at least a portion of the phrase suggestion engine 302 could be implemented on a merchant device, e.g. on merchant device 102 of FIG. 3 or on merchant device 320 described below. For example, the merchant device could store and run some or all of the phrase suggestion engine 302 locally as a software application.

The phrase suggestion engine 302 of system 300 may include a processor 304, a network interface 306, and a memory 308. The network interface 306 is for communicating over the network 310. The network interface 306 may be implemented as a network interface card (NIC), and/or a computer port (e.g. a physical outlet to which a plug or cable connects), and/or a network socket, etc., depending upon the implementation. The processor 304 directly performs, or instructs the phrase suggestion engine 302 to perform, the operations of the phrase suggestion engine 302. The processor 304 may be implemented by one or more general purpose processors that execute instructions stored in a memory (e.g. in memory 308) or stored in another non-transitory computer readable medium. The instructions, when executed, cause the processor 304 to directly perform, or instruct the phrase suggestion engine 302 to perform, the operations described herein. In other embodiments, the processor 304 may be implemented using dedicated circuitry, such as a programmed FPGA, a GPU, or an ASIC. The memory 308 may include a phrase library 309, which will be described in more detail later.

In some embodiments, the phrase suggestion engine 302 may be implemented inside of an e-commerce platform. In some embodiments, the processor 304, memory 308, and/or network interface 306 may be located outside of the phrase suggestion engine 302.

The phrase suggestion engine 302 may communicate with the search engine 311 in order to obtain search query data, e.g, in the manner described later. The search engine 311 may be implemented by a processor, such as processor 304 or a different processor. The processor may be implemented by one or more general purpose processors that execute instructions stored in a memory or stored in another non-transitory computer readable medium. The instructions, when executed, cause the processor to directly perform, or instruct the search engine 311 to perform, the operations described herein. In other embodiments, the processor may be implemented using dedicated circuitry, such as a programmed FPGA, a GPU, or an ASIC.

In some embodiments, the search engine 311 may be implemented inside the phrase suggestion engine 302.

A plurality of merchants may access the phrase suggestion engine 302 over the network 310 using merchant devices. For ease of explanation, only a single merchant device 320 is illustrated in FIG. 4, The merchant device 320 includes a processor 322, a memory 324, a user interface 328, and a network interface 326. The processor 32.2 directly performs, or instructs the merchant device 320 to perform, the operations of the merchant device 320 described herein, e.g. communicating with the phrase suggestion engine 302 to receive alternative phrases, displaying the alternative phrases through the use of a display 329 in user interface 328, modifying the text-based content to display an alternative phrase in place of the original phrase, etc. The processor 322 may be implemented by one or more general purpose processors that execute instructions stored in a memory (e.g. memory 324) or stored in another non-transitory computer-readable medium. The instructions, when executed, cause the processor 322 to directly perform, or instruct the merchant device 320 to perform, the operations described herein. In other embodiments, the processor 322 may be implemented using dedicated circuitry, such as a programmed FPGA, a GPU, or an ASIC. The user interface 328 may be implemented as a display screen 329 (which may be a touch screen), and/or a keyboard, and/or a mouse, etc., depending upon the implementation. The network interface 326 is for communicating with the phrase suggestion engine 302 over the network 310. The structure of the network interface 306 will depend on how the merchant device 320 interfaces with the network 310. For example, if the merchant device 320 is a mobile phone or tablet, the network interface 326 may comprise a transmitter/receiver with an antenna to send and receive wireless transmissions to/from the network 310. If the merchant device 320 is a personal computer connected to the network 310 with a network cable, the network interface 326 may comprise a network interface card (NIC), and/or a computer port (e.g. a physical outlet to which a plug or cable connects), and/or a network socket, etc.

Operation of the system 300 will now be described.

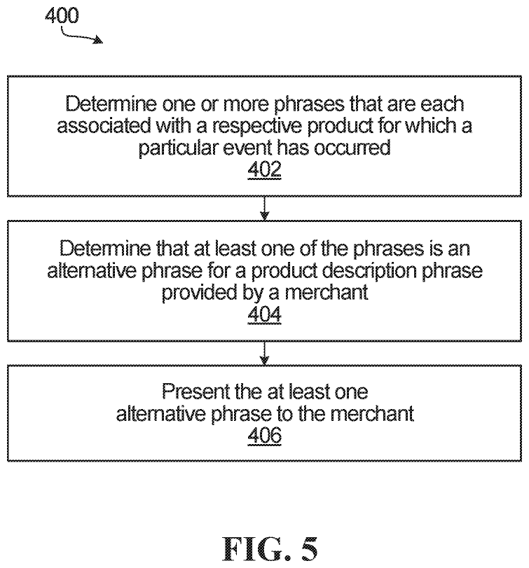

FIG. 5 illustrates a computer-implemented method 400 performed by the phrase suggestion engine 302, according to one embodiment. The method may be performed in order to determine alternative phrases for one of one or more pieces of text-based content associated with one or more products in a merchant's store by performing the following steps/operations.

At step 402 of FIG. 5, the processor 304 of the phrase suggestion engine 302 determines one or more phrases that are each associated with a respective product for which a particular event has occurred. An example of a particular event may be a sales conversion rate exceeding 10%. In one example, the processor 304 of the phrase suggestion engine 302 determines that a product for which this event has occurred is a dog collar with embedded lights, and that some phrases describing such a dog collar include “LED Safety Collar for Dogs” and “light-up dog collar”. Example manners of implementing step 402 are described later.

At step 404, the processor 304 of the phrase suggestion engine 302 determines that at least one of the phrases is an alternative phrase for a product description phrase provided by a merchant. For example, a merchant may be generating a product webpage and enter the product title “Glow Collar for Dogs”. The processor 304 of the phrase suggestion engine 302 may determine that the phrases “LED Safety Collar for Dogs” and “light-up dog collar” identified in step 402 may be an alternative phrase for the merchant's product title “Glow Collar for Dogs”. Example manners of implementing step 404 are described later.

At step 406, the one or more alternative phrases are presented to the merchant on the display 329 of the user interface 328 of the merchant device 320. For example, the phrases “LED Safety Collar for Dogs” and “light-up dog collar”, which have been identified as alternatives to the phrase “Glow Collar for Dogs” by the phrase suggestion engine 302, may be presented to the merchant on the display 329 of his merchant device 320.

Alternatively, steps 402 and 404 of method 400 may be combined or reversed in some embodiments.

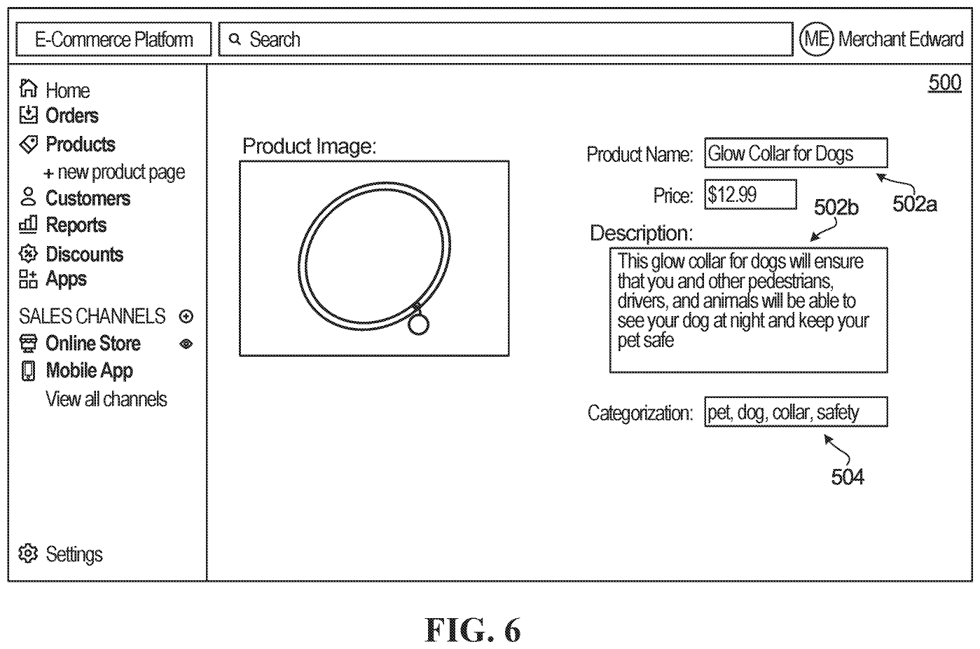

FIG. 6 illustrates an example product webpage generation interface 500 for one product within a merchant store. The merchant, here known as “Merchant Edward”, sells pet-related items including dog collars. Product webpage generation interface 500 is used by Merchant Edward to generate a product webpage to sell a product, herein exemplified as a dog collar with embedded lights. The product webpage generation interface 500 allows Merchant Edward to select one or more images that he would like to include on the product webpage and a product price. As well, the product-webpage generation interface 500 allows Merchant Edward to enter text-based content 502a and 502b. Here, Merchant Edward has entered in “Glow Collar for Dogs” as product name 502a and a description of the product 502b. Product name may alternatively be called product title. Additionally, Merchant Edward is able select categories used to classify the product. In the illustrated example, Merchant Edward has classified the dog collar with embedded lights under “pets”, “dogs”, “collar”, and “safety” 504.

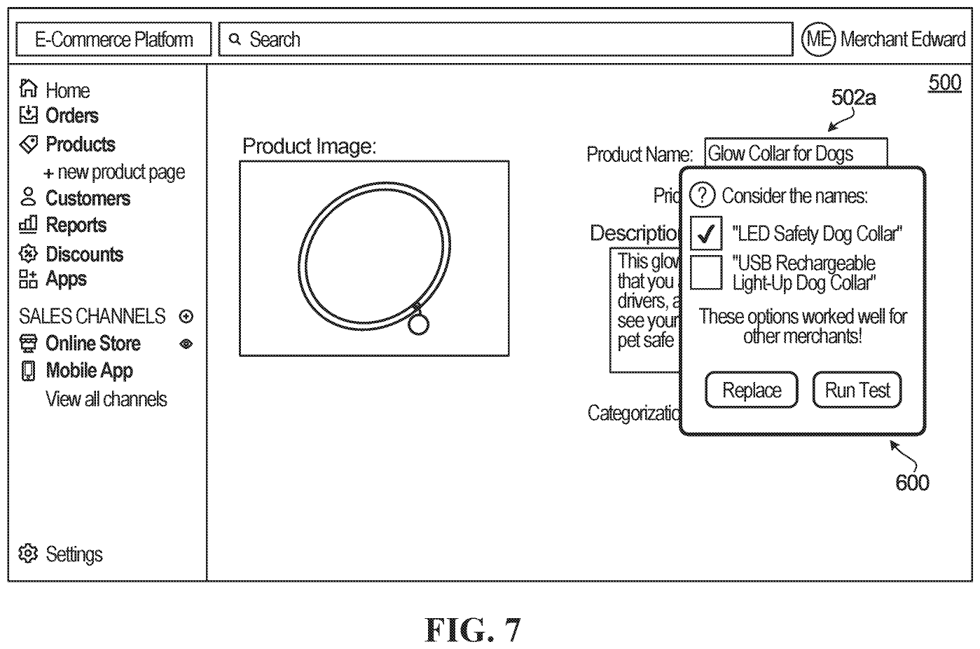

FIG. 7 illustrates the example product webpage generating interface 500 of FIG. 6 in an embodiment in which the phrase suggestion engine 302 is being utilized. Merchant Edward has entered in a piece of text-based content 502a, here the product name “Glow Collar for Dogs”. In response, a pop-up window 600 is displayed having alternative phrase suggestions that were generated by the phrase suggestion engine 302. Pop-up window 600 provides Merchant Edward with alternative phrase suggestions in real-time (or near real-time) for the product name. In the illustrated example, the alternative phrase suggestions are “LED Safety Dog Collar” and “USB Rechargeable Light-Up Dog Collar”, which are associated with a product sold by another merchant for which a particular event has occurred. Merchant Edward may select one of these alternative phrases to replace his current product name while generating his product webpage.

Determining that a Phrase is Associated with a Product for which a Particular Event has Occurred

In some embodiments, e.g. like in step 402 of FIG. 5, when determining alternative phrases for a product, the suggested alternative phrase is associated with a product for which a particular event has occurred. The particular event may be any event defined in the system that may be correlated with interest in the product. in some embodiments, the particular event may be a quantifiable metric that indicates a high level of interest in the product by consumers, e.g. a high sales conversion rate.

Example events include one or more of the following: a sales conversion rate exceeding a particular threshold; an add-to-cart rate above a particular threshold; a click-through rate above a particular threshold (e.g. the click-through rate from the results of a search engine to a product-webpage above a particular threshold, or a click-through rate from an online advertisement to a product webpage above a particular threshold, etc.); an average duration of time spent on the product webpage by the consumer exceeding a particular threshold; a high frequency (e.g. above a threshold) of consumers clicking a link on the product webpage that expands a partially-collapsed description of the product; a high frequency (e.g. above a threshold) of consumers sharing a product webpage with their social networks; and/or the number of positive reviews left on a product webpage exceeding a particular threshold.

As is clear from the foregoing examples, the event can be basically any event defined in the system, which may be correlated with interest in a product.

In some embodiments, the merchant may be able to select the particular events used by the phrase suggestion engine 302 for determining alternative phrases associated with text-based content within the merchant's store. For example, the merchant may opt to set the particular event as an average duration of time spent on the product webpage by the consumer exceeding a particular threshold, and then later change the event to be a sales conversion rate exceeding a particular threshold.

In some embodiments, the occurrence of more than one particular event may be considered when determining alternative phrases associated with text-based content within the merchant's store. For instance, and simply by way of example, three particular events may be chosen as: (1) a sales conversion rate exceeding a particular threshold, (2) an add to cart rate exceeding a particular threshold, and (3) a click-through rate exceeding a particular threshold (each of the thresholds being, potentially, individually configurable to allow a different respective threshold for each rate being considered). The phrase suggestion engine 302 may analyze a particular product and (a) require for all three particular events to have occurred to be an alternative phrase for the text-based content, or (b) require for at least one of the three particular events to have occurred to be considered as an alternative phrase, or (c) require two of the three particular events to have occurred to be considered as an alternative phrase, which may be based on a particular rule (e.g. logical expression) stored in memory 308.

When a particular event has occurred for a product, phrases describing that product are determined. In some embodiments, this may be implemented by selecting one, some, or all of the phrases present on a webpage describing that product. For instance, one, some, or all of the phrases that make up the product title and/or product description on the product webpage may be selected.

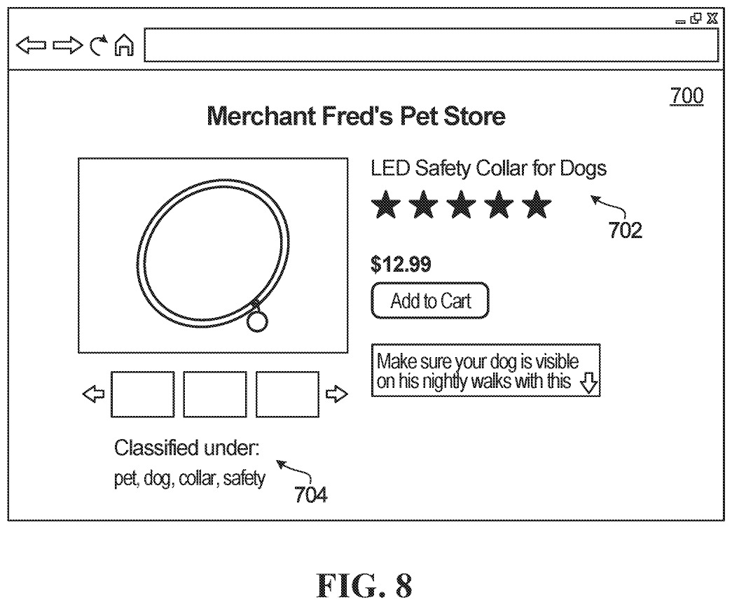

As an example, FIG. 8 illustrates a webpage 700 associated with the product “LED Safety Collar for Dogs” sold by another merchant referred to herein as “Merchant Fred”. This product has been determined to be associated with a particular event, which here is defined as a sales conversion rate exceeding 10%. The product title 702 on Merchant Fred's webpage (i.e, the phrase “LED Safety Collar for Dogs”) is selected to be a phrase associated with the product.

In other implementations, a search query entered into search engine 311 may be a phrase that is associated with the product for which the particular event has occurred. For instance, a search query may lead a consumer to visit the product webpage for a product associated with the particular event. In some embodiments, the click-through resulting from the search query may be the particular event; however, in some embodiments, taking a particular action after arriving on the webpage via the search query, such as purchasing the product, may be defined as the particular event.

In some embodiments, the particular event may be defined by or in relation to the search query. For example, the search query “dog collar for at night” might or might not be a frequently used search query; however, the phrase suggestion engine 302 may determine that the subsequent sales conversion rate resulting from click-throughs to a merchant's product webpage from the search query “dog collar for at night” is high. As a result, this search query may be deemed to be a phrase that is associated with a product for which a particular event has occurred. In this example, the particular event is a high sales conversion rate when the search query entered is “dog collar for at night”.

In some embodiments, only search queries that are frequently searched using search engine 311 may be considered. For example, an alternative phrase may need to be a search query that is frequently searched and the phrase may need to be associated with a product for which a particular event occurred in order to be considered.

In some embodiments, the search engine 311 may be hosted by an e-commerce platform, e.g. e-commerce platform 100. In such an implementation, the search queries resulting in a user arriving at a particular product webpage and subsequent follow-on action, for example purchasing the product, may be directly traced within the e-commerce platform. For instance, the search query entered by the user may be stored within the data of the e-commerce platform, and their website navigation path may be tracked.

In implementations in which the search engine 311 is external to the e-commerce platform, the phrase suggestion engine 302 may need to obtain an indication of the search query, or the keywords within the search query, used to arrive at the merchant's webpage.

For example, a user may use the Google™ search engine to search the query “dog collar for at night” and the search results may include a product webpage belonging to a particular merchant. The user may click on the search result link for that merchant's product webpage, arrive at the merchant's product webpage, and subsequently purchase the product. The phrase suggestion engine may determine which search query, or keywords within a search query, were used in the user's search that provide them with the clicked-on search result link. In one embodiment, this information is determined as follows: (1) The user clicks on the search result link for the merchant's website provided by the search engine. (2) A HTTP request is sent to the web server on the e-commerce platform hosting the merchant's website. The information sent as part of the HTTP request includes information that allows for the system to determine which search query term generated the search results. For instance, the search query terms may be embedded in the HTTP request. Alternatively, a token may be included as part of the HT TP request that maps to particular search terms. If a token is used, the e-commerce platform requires the mapping, which may be separately provided by the search engine 311. In some embodiments, the tokens may be provided in batches to the e-commerce platform, with each token acting as a unique identifier. The token may be or include a hex suing. Additionally or alternatively, the token may include one or more of the following datum: a timestamp; the page ranking within the search results provided by the external search engine 311; which, if any, other search result links were clicked on prior to the merchant's product webpage, the keywords used within the search query, etc.

In some embodiments, a phrase library 309 may be stored within the memory 308 of the phrase suggestion engine 302. The phrase library 309 includes lists of candidate alternative phrases, each associated with a respective product for which a particular event has occurred. The library may be established and maintained in non-real time, e.g. upon determining when particular events have occurred in relation to products on an e-commerce platform. After the processor 304 of the phrase suggestion engine 302 begins executing method 400, the processor 304 determines if one or more phrases from the phrase library 309 are associated with the merchant's text-based content.

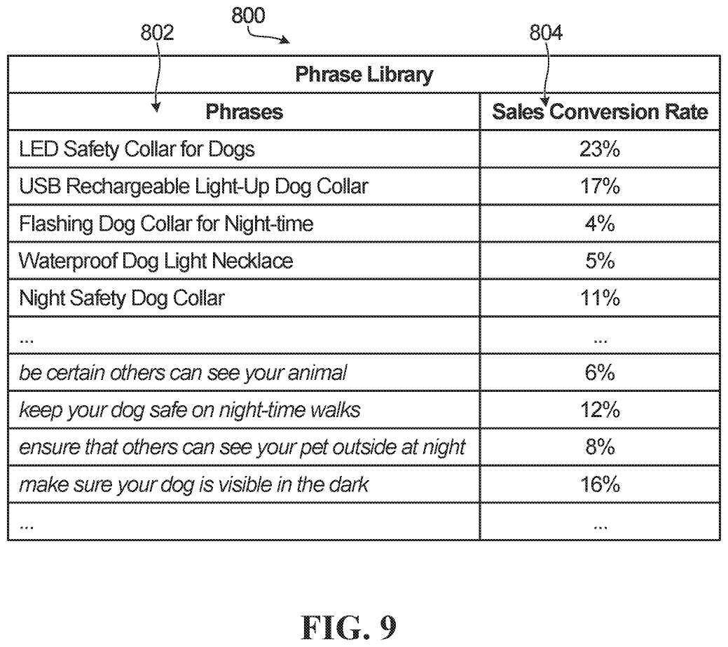

FIG. 9. is an example implementation of the phrase library 309 stored as a data structure 800 within the memory 308 of phrase suggestion engine 302. The phrase library 309 includes several phrases 802 that are each respectively associated with the occurrence of a particular event 804. For example, phrase library 309 in the illustrated embodiment stores phrases 802 including “LED Safety Collar for Dogs”, “USB Rechargeable Light-Up Dog Collar”, and “Flashing Dog Collar for Night-time”, which are associated with sales conversion rates 804 of 23%, 17%, and 4% respectively. The sales conversion rate 804 may be determined based on the average sales conversion rate of all products that include that phrase as text-based content within its product webpage. In some embodiments, the phrases 802 stored within phrase library 800 may be presented to a merchant in real-time (or near real-time) when the merchant is entering text-based content into a webpage relating to a product for sale by that merchant. For instance, in FIG. 7, while Merchant Edward is entering product name 502a, the alternative phrase suggestions presented to Merchant Edward in real-time using pop-up window 600 may be phrases that are stored in phrase library 309.

### Determining Alternative Phrases for a Particular Phrase Entered by a Merchant

In some embodiments, e.g. like in step 404 of FIG. 5, a link is established between the text-based content entered by the merchant and the alternative phrase in order for the phrase to be considered an alternative phrase for a piece of text-based content relating to a product.

In some embodiments, the link between a piece of text-based content and an alternative phrase may be established as a result of similar product categorization or classification. Each product sold by each merchant may be associated with one or more product-level classifications. In implementations where the phrase suggestion engine 302 is used in conjunction with an e-commerce platform, these classifications may be manually selected when the merchant adds a product to their online store using the e-commerce platform. The phrase suggestion engine 302 may then identify all products sold by other merchants that have one or more of the same classifications as the merchant's product; subsequently, the system obtains potential alternative phrases from these like-classified products. If a particular event has occurred for these like-classified products (e.g. the like classified products have a high sales conversion rate), these alternative phrases associated with the product will be presented to the merchant.

For example, with reference to FIG. 6, Merchant Edward is selling a dog collar that emits light, and has entered the product name in product webpage generation interface 500 as “Glow Collar for Dogs” in text-based content 502a. Merchant Edward categorizes this product under the classifications: “pet” “dog”, “collar”, and “safety” in text-based content 504. In this example, a different Merchant Fred also generates his online store using the e-commerce platform used by Merchant Edward. Merchant Fred sells a product “LED Safety Collar for Dogs”, as seen on webpage 700 for this product illustrated in FIG. 8. The product offered by Merchant Fred is also categorized under the classifications “pet”, “dog”, “collar”, and “safety”, as shown at 704. If a particular event has occurred for Merchant Fred's product (e.g. the product has a high sales conversion), the product name 702 “LED Safety Collar for Dogs” may be recommended to Merchant Edward as an alternative phrase to use within his product webpage.

In implementations where both merchants do not employ the same e-commerce platform, the phrase suggestion engine 302 may attempt to determine the categorization of different products based on the webpages (e.g. product webpages) for those products. For the merchant generating the web content, the phrase suggestion engine 302 may prompt the merchant to manually enter product classifications; alternatively, the phrase suggestion engine 302 may analyze the text-based content included in/on the webpage to attempt to classify the product. Prior to assigning product classifications, the phrase suggestion engine 302 may prompt the merchant to confirm that the product has been correctly classified.

For instance, Merchant Edward may generate a product webpage for the product “Glow Collar for Dogs” without the use of an e-commerce system; however, there is no product classification. When the phrase suggestion engine 302 is executed, it may analyze terms within the text-based content and determine keywords. A prompt message may appear on the user interface, having determined that the product may be classified using the terms: “pet”, “dog”, “collar”, and “safety”, and asking Merchant Edward if he agrees with this categorization.

In an implementation where the merchant selling a similar product (Merchant Fred in the example above) does not use an e-commerce system, the phrase suggestion engine 302 may similarly attempt to determine the keywords on a product webpage belonging to that merchant. The phrase suggestion engine 302 may determine the keywords to be associated with particular categorizations or classifications if a particular threshold of certainty has been exceeded, e.g. if a word appears a certain number of times on a product webpage it is considered a keyword, and if that keyword also appears in the product name it is considered a classification word. For example, the phrase suggestion engine 302 may perform the following operations for a webpage describing a product: (1) parse out any words in the webpage that are identified as nouns, verbs, or adjectives, which may optionally be accomplished through a process of elimination by filtering out words that are known prepositions, conjunctions, etc.; (2) count the number of times each of the remaining words appears in the webpage; (3) for any word that appears very frequently (e.g. more often than a certain relatively high percentage of time, such as more often than 5% of the time), select that word as a keyword and/or as a classification; (4) for any word that appears somewhat frequently (e.g. within a certain percentage range, such as between 2% to 5% of the time), select that word as a classification if the word also appears in a product name/field of the webpage.

In another embodiment, keywords are extracted from the product description phrase provided by a first merchant (e.g. from a first merchant's product webpage), and the phrase suggestion engine 302 then determines one or more other merchants that sell a product described using all or a subset of the keywords. The alternative phrases are obtained from the webpages of these other merchants and provided to the first merchant if the phrases are associated with products for which a particular event has occurred. For example, Merchant Edward includes the phrase “glow collar for dogs” in his product description 502b of FIG. 6. The phrase suggestion engine 302 extracts the keywords “glow”, “collar”, and “dog”. Merchant Fred's product webpage for the product “LED Safety Collar for Dogs” (shown in FIG. 8) describes the collar as glowing, as it also includes the phrases “glow” and “collar”. Merchant Fred describes his product as “LED safety collar for dogs”. Merchant Fred's product is also associated with a particular event (e.g. sales conversion rate above 10%). The phrase suggestion engine 302 therefore determines that “LED safety collar for dogs” is an alternative to the phrase “glow collar for dogs”. The phrase “LED safety collar for dogs” may therefore be recommended to Merchant Edward, e.g. as shown in window 60( )of FIG. 7.

In some implementations, only a subset of the keywords provided by the first merchant (e.g. Merchant Edward) may need to match descriptive words on the product webpage of a second merchant (e.g. Merchant Fred) in order to consider alternative phrases from the webpage of the second merchant. For example, a match of only a subset of the provided keywords may need to be provided such as, for example, if the phrase suggestion engine 302 determines that the second merchant sells products within the same industry as the first merchant and/or if the second merchant's product is classified in the same manner as the first merchant's product. For instance, the phrase “LED safety collar for dogs” used by Merchant Fred may be identified as an alternative to “glow collar for dogs”, even though Merchant Fred does not include the keyword “glow” in his product description, because both Merchant Fred and Merchant Edward's online stores belong to the pet-care industry. The matching of at least one common keyword and a matching of the same industry and/or product classification provides enough confidence for the phrase suggestion engine 302 to select “LED safety collar for dogs” as an alternative product description phrase for “glow collar for dogs”.

In yet another embodiment, alternative phrases may be identified based on phrases used by consumers in search queries that share one or more keywords with the product description phrase provided by the merchant. If the phrase used in the search query is also associated with a particular event, it may be recommended to the first merchant as an alternative phrase. For example, Merchant Edward's product webpage includes the phrase “Glow Collar for Dogs” as the product name. If the phrase “dog collar for at night” is often searched in search queries, the phrase suggestion engine 302 may identify the phrase “dog collar for at night” as an alternative for Merchant Edward's product name as the two phrases share the keywords “collar” and “dog”. If the phrase “dog collar for at night” is also associated with one or more products for which a particular event has occurred (e.g. a sales conversion rate exceeding 10%), the phrase may be recommended to Merchant Edward.

In some implementations, only search query phrases frequently used in web searches may be considered as candidate alternative phrases; conversely, in other implementations, any search query phrases may be considered as candidate alternative phrases, as long as they are associated with one or more products for which a particular event has occurred. Search query phrases may be obtained from a third-party search engine, such as by search engine 311 in FIG. 4, or tracked internally within an e-commerce platform if the e-commerce platform hosts its own search engine, such as search engine 208 in FIG. 3.

### Scoring

Although one or more alternative phrases may be identified for a particular piece of text-based web content provided by a merchant, not every alternative phrase is necessarily presented to the merchant. The phrases presented to the merchant may further be ranked.

In one embodiment, a numeric score is assigned to each alternate phrase presented to the merchant. The numeric score may be determined based on factors including the particular event that occurred for the product associated with that alternative phrase and/or the similarity between the alternative phrase and the original phrase.

For instance, Merchant Fred describes a product using the phrase “LED Safety Collar for Dogs”, as illustrated in FIG. 8. If the particular event is defined by the sales conversion rate, and Merchant Fred's product has a 10% sales conversion rate, a score of 10 may be assigned to the phrase. The score may be adjusted, e.g. reduced, based on how similar the phrase is to that originally provided by a merchant using the phrase suggestion engine 302. For example, if “LED Safety Collar for Dogs” is selected as an alternative phrase to “glow collar for pets”, then the score of 10 may be reduced because only one word (“collar”) is the same between the alternative phrase and the original phrase.

As another example, if several products individually containing the phrase “LED safety collar for dogs” are sold by a plurality of merchants, and the average sales conversion rate is 7%, then a score of 7 may be assigned to the phrase.

In some embodiments, an alternative phrase for a piece of text-based content in a merchant's online store may only be presented to that merchant if the score exceeds a particular threshold. if more than one alternative phrase is presented to the merchant, the phrases may be presented in order of score such that the alternative phrase having the highest score is listed at the top of the suggestion list.

In some embodiments, the score assigned to a particular alternative phrase may also or instead be based on the frequency with which that alternative phrase was used as a search query within a search engine, e.g. within search engine 311.

### Split Testing

In some embodiments, a user-interface may be provided to allow the merchant to configure split (“A/B”) testing in order to test which ones of the alternative product description phrases results in a better outcome for that merchant.

The merchant may configure several variables of the AIB test. This may include the outcome under test, e.g. is it a sales conversion, or add-to-cart, or clicking the link on the product webpage that opens the collapsed product description, etc. The phrases to place under test may also or instead be configurable. The parameters of the A/B test may also or instead be configurable. The parameters may include the percentage of webpage accesses that will show the consumer phrase A versus phrase B, as well as the duration of the A/B testing, measured in either a duration of time or a number of visitors to the webpage describing the product.

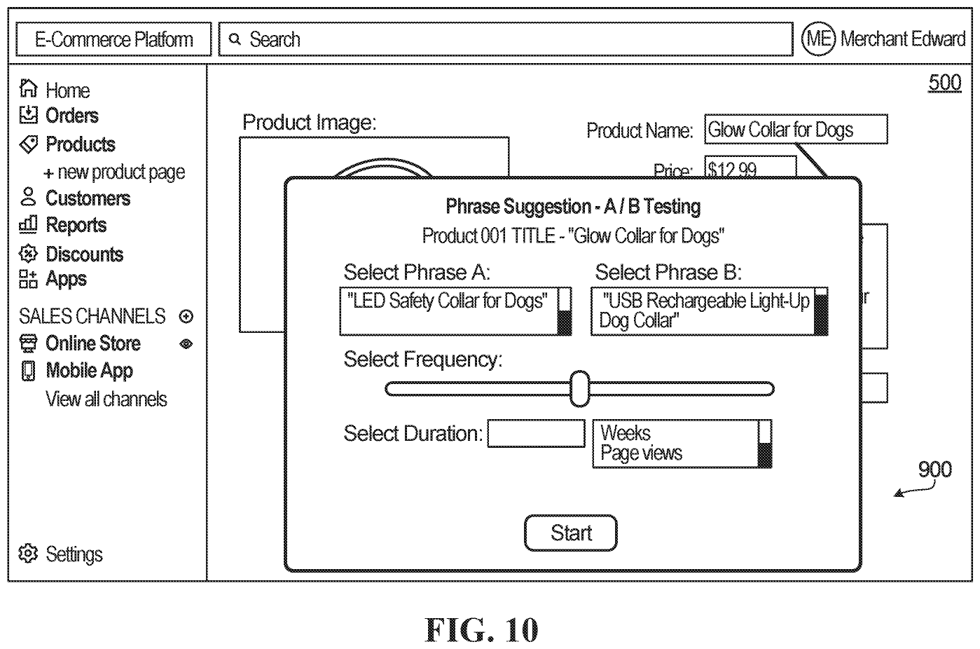

FIG. 10 illustrates an example user interface to configure split testing after enabling the phrase suggestion engine 302 for the product webpage being generated for the product named “Glow Collar for Dogs” in Merchant Edward's store. After choosing to view the alternative phrases presented by the phrase suggestion engine 302, a pop-up window 900 may be provided to Merchant Edward, The pop-up window 900 displays the piece of text-based content that may be replaced, here Product 001 TITLE—“Glow Collar for Dogs”, and allows Merchant Edward to select two alternative phrases to test against one another from a list of phrases. Here, the phrase “LED Safety Collar for Dogs” is selected as Phrase A and “USB Rechargeable Light-Up Dog Collar” is selected as Phrase B. The pop-up window 900 also includes a slider that allows Merchant Edward to select how often he would like a potential consumer to view his text-based content as “LED Safety Collar for Dogs” and how often he would like the consumer to instead see the product title “USB Rechargeable Light-Up Dog Collar”. Lastly, Merchant Edward is able to enter in the duration that he would like to run the split testing of the product's title. In the illustrated embodiment, the duration may be measured in time (e.g. number of weeks) or number of page views.

### Example use Cases and Methods

The embodiments of the phrase suggestion engine 302 may be used in several different ways, e.g. within a merchant's online store.

In some embodiments, a merchant may enter a new product into their online store, but the merchant may be unsure how to refer to the product to garner the most interest. The merchant may enter a piece of text-based content, which results in the phrase suggestion engine 302 providing a pop-up window suggesting an alternative phrase for the text-based content. For each suggestion presented to the merchant, an option is presented to the merchant that allows them to run a split testing experiment instead of immediately replacing the text-based content. If the merchant opts to run the experiment, the merchant is presented with multiple alternatives to the initial alternative phrase suggestion. The merchant is able to select as many of the alternative phrase suggestions as they like, and the phrase suggestion engine 302 automatically runs A/B testing with the selected phrases for a recommended, but configurable, duration. Following the completion of the A/B testing, the phrase suggestion engine reports 302 the test's results to the merchant, presenting a recommendation of which phrase the merchant should select. Alternatively, the phrase suggestion engine 302 may automatically modify the text-based content to use the testing-determined phrase recommendation,

For example, FIG. 7 shows the product webpage generation interface 500 of a product being entered into Merchant Edward's store. Merchant Edward enters the product name “Glow Collar for Dogs” 502a and the pop-up window 600 appears. The pop-up window 600 presents the alternative phrases “LED Safety Dog Collar” and “USB Rechargeable Light-Up Dog Collar” to Merchant Edward, and allows him to replace his product name with one of these alternative phrases or to run a test. If Merchant Edward chooses to run a test, the pop-up window 900 of FIG. 10 appears on the user interface. Pop-up window 900 allows Merchant Edward to select which alternative phrases to test and to configure other criteria of the experiment. After the testing duration has elapsed, Merchant Edward may be recommended to set the product name to one of the phrases, for example “LED Safety Collar for Dogs”, which resulted in the more favourable outcome.

In another embodiment, the merchant may already have several products loaded into their store. The merchant may run the phrase suggestion engine 302, and a pop-up may be presented to the merchant 302 that includes a list of alternative phrase suggestions for various pieces of text-based content across the merchant's online store. The merchant then selects which, if any, of the alternative phrase suggestions they would like to use in their online store,

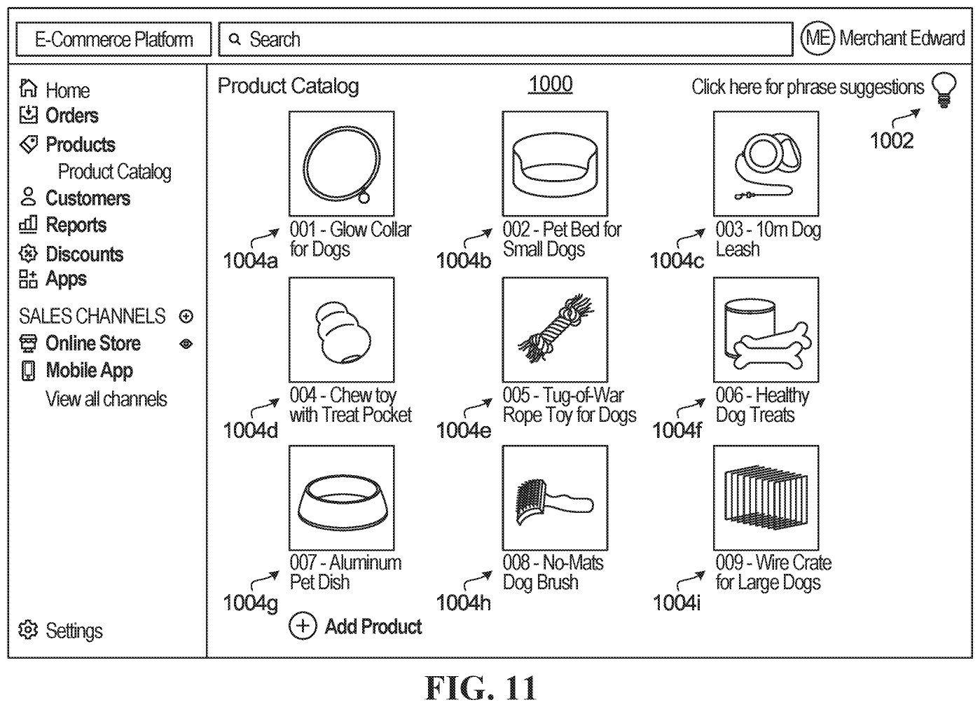

For example, FIG. 11 shows a user interface used by Merchant Edward to modify the products within his online store. His product catalog 1000 lists products “001-Glow Collar for Dogs” to “009-Wire Crate for Large Dogs”, i.e. products 1004a-i appearing in his online store that sells pet-care items for dogs. An icon and the prompt “click here for phrase suggestions” 1002 is presented on the user interface for Merchant Edward to begin using the phrase suggestion engine 302.

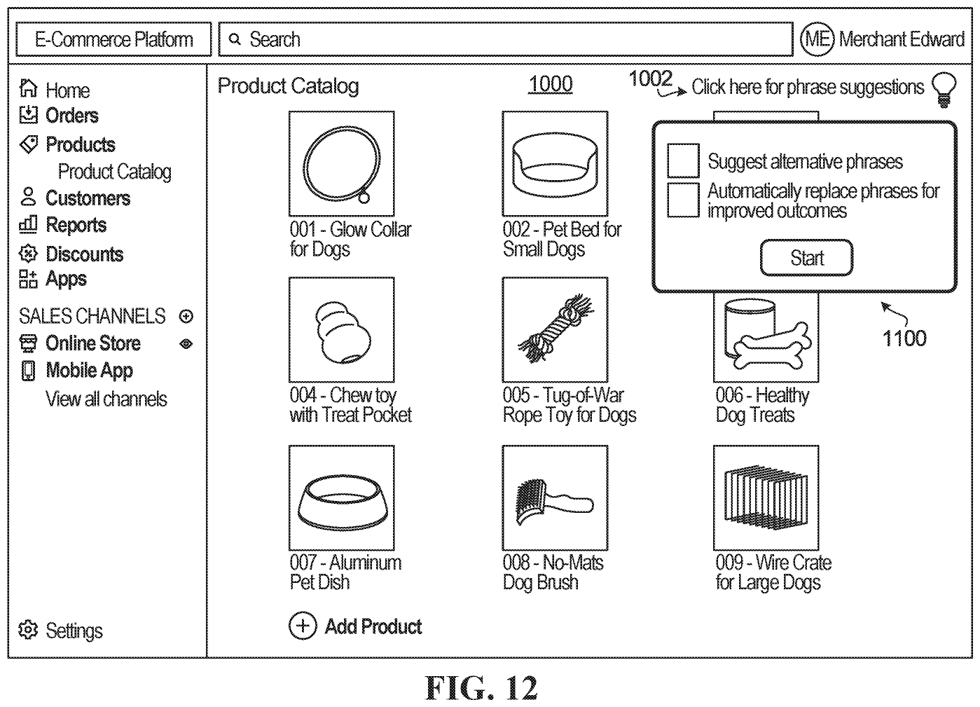

Once the phrase suggestion engine 302 is enabled by clicking on icon 1002, Merchant Edward may be presented with the user interface of FIG. 12. FIG. 12 includes a prompt window 1100, in which the first selectable option provides alternative phrase suggestions to the text-based content across his product catalog 1000.

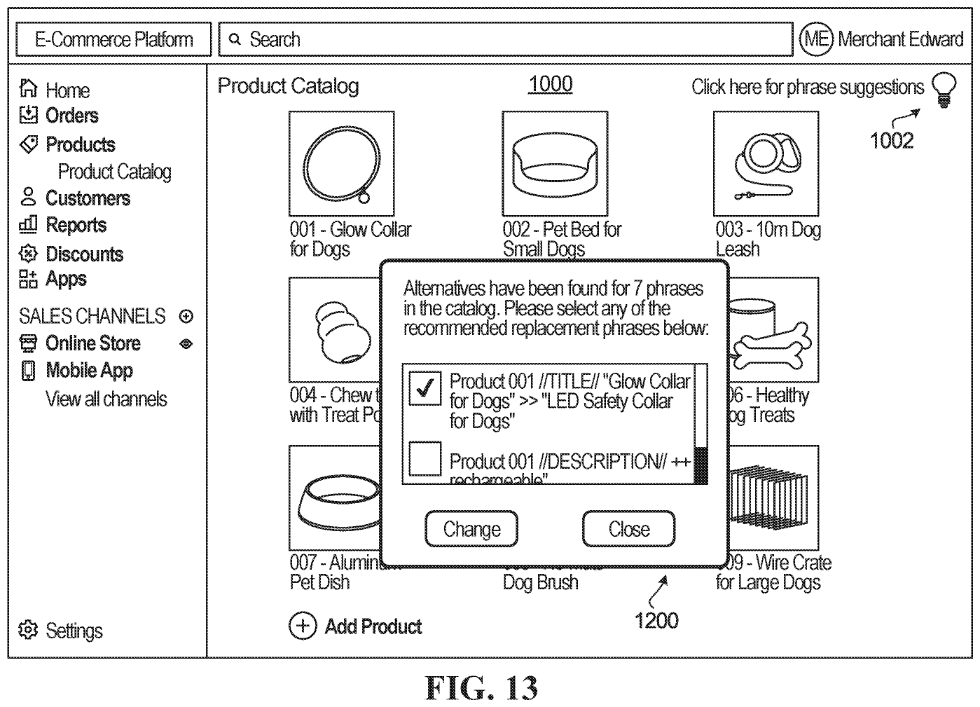

After selecting this option and clicking on the “start” button, Merchant Edward is presented with the pop-up window 1200 illustrated in FIG. 13. The pop-up window 1200 includes a scrollable list of seven selectable alternative phrases. For instance, the first suggestion that appears is a suggestion to replace the title of product 001, presently “Glow Collar for Dogs”, with the phrase “LED Safety Collar for Dogs”. Merchant Edward is then able to select which, if any, of the recommendations provided by the phrase suggestion engine 302 he wishes to implement by clicking on the checkbox beside the recommendation fol lowed by the “change” button.

In another embodiment, the merchant also has a variety of products loaded into their online store. Instead of the merchant selecting alternative phrases amongst a variety of presented recommendations, the phrase suggestion engine 302 automatically updates text-based content in the merchant's store to reflect its recommendations.

For example, Merchant Edward may select the option “Automatically replace phrases for improved outcome” fr©m the pop-up window 1100 of FIG. 12. The phrase suggestion engine 302 then runs and replaces several pieces of text-based content across Merchant Edward's product catalog with alternative phrases.

FIG. 1A illustrates a user interface where the product suggestion engine 302 has automatically replaced text-based content within Merchant Edward's product catalog 1000. The pop-up window 1300 presented to Merchant Edward indicates the number of instances in which text-based content has been replaced, and provides him with the option to view the changes made or to close the window. For instance, within the product catalog, the product title of products 001 and 003 have been replaced with alternative phrases indicated by the phrase suggestion engine 302. Following the use of the phrase suggestion engine 302, “Glow Collar for Dogs” 1004a has been replaced with the phrase “LED Safety Collar for Dogs” 1304a and “1 OM Dog Leash” 1004c has been replaced with the phrase “10m Retractable Dog Leash” 1304c.

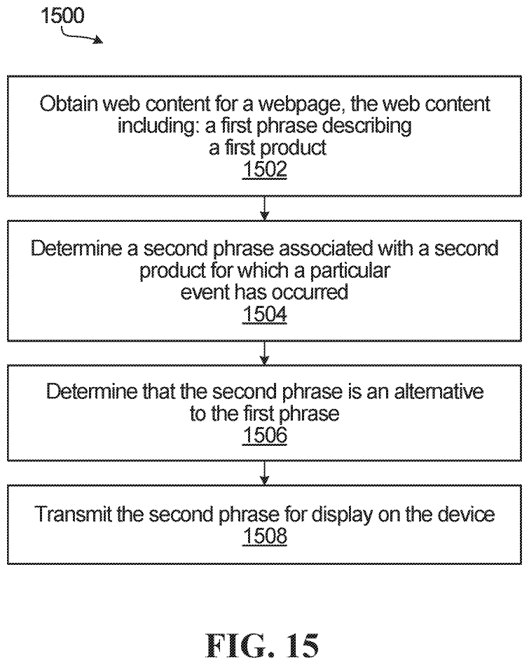

FIG. 15 illustrates a computer-implemented method 1500, according to one embodiment. The method may be performed by a computing device (e.g. a processor or combination of processors such as the processor 304 in phrase suggestion engine 302). The method will be described as being performed in phrase suggestion engine 302 of FIG. 4, but this is not necessary. For example, the method could instead be performed by another device that might or might not be part of an e-commerce platform.

At step 1502, the processor 304 obtains web content for a webpage, where the web content includes a first phrase describing a first product. An example of a web content is the product name, such as the product name “Glow Collar for Dogs” 502a illustrated in FIGS. 6, 7, and 10. The product name “Glow Collar for Dogs” describes the product of a dog collar with embedded lights, and the entire phrase of “Glow Collar for Dogs”, or each term within the phrase, or a combination of some of the words within the phrase may be the web content obtained. In some embodiments, the web content may be obtained in real-time (or near real-time; when the merchant is generating the web content, e.g. when the merchant is building the product page. Examples of web content include any text element on a web page, e.g. product name, a header on the webpage, a text banner, an image capture, webpage metadata, etc.

At step 1504, the processor 304 determines (e.g. identifies) a second phrase that has an association with a second product for which a particular event has occurred. Example ways in which a second phrase is determined are described above. In some embodiments, the second phrase may be determined by first determining that a second product is associated with occurrence of a particular event, and then selecting a product description phrase from a webpage describing that second product. Example of particular events are described above and may include: a sales conversion rate exceeding a particular threshold; and/or an add-to-cart rate above a particular threshold; and/or a click-through rate above a particular threshold; and/or an average duration of time spent on the product webpage by the consumer exceeding a particular threshold; and/or frequent instances of consumers clicking a link on the product webpage that expands a partially-collapsed description of the product; and/or frequent instances of consumers sharing a product webpage with their social networks; and/or the number of positive reviews left on a product webpage exceeding a particular threshold, etc.

As one example of step 1504, the phrase suggestion engine 302. determines that the product sold on Merchant Fred's webpage of FIG. 8 has a sales conversion rate exceeding a particular threshold and determines that the phrase “LED Safety Collar for Dogs” is associated with that product (e.g. describes the product) because it is the product name of Merchant Fred's product. The phrase “LED Safety Collar for Dogs” is therefore determined as the “second phrase”. In some embodiments, a second phrase may also or instead be determined based on search queries leading to product webpages associated with an occurrence of a particular event. In some embodiments, a second phrase may be determined through the use of a phrase library, such as phrase library 800 in FIG. 9,

At step 1506, the processor 304 determines that the second phrase is an alternative to the first phrase. This determination may be made using at least one of the previously described approaches, e.g. based on the first phrase and the second phrase having matching keywords and/or based on the products associated with the first and second phrases having a matching classification and/or based on the merchants associated with the first and second phrases selling products in a same industry, etc.

At step 1508, the processor 304 transmits the second phrase for display on the device, e.g. on the merchant device of the merchant providing the web content. In some embodiments, the second phrase is presented on the display 329 of user interface 328 of the merchant device 320, such that the merchant is presented with alternative phrases for the text-based web content on the product-related -webpage.

In some embodiments of the method of FIG. 15, the particular event is that the sales conversion rate of the second product is above a particular threshold. As a simple example, at step 1504, the threshold that must be exceeded for a second phrase associated with a second product to be considered an alternative phrase is a sales conversion rate of 10% for the second product. In the example in FIG. 9, the sales conversion rate is 23%, and so the threshold is met.

In some embodiments, determining the second phrase at step 1504 of the method of FIG. 15 includes determining a phrase used in a webpage that describes a second product. For instance, the second phrase “LED Collar for Dogs” is used in the webpage shown in FIG. 8, which is a product webpage 700 for a light-up dog collar in Merchant Fred's online store.

In some embodiments, determining the second phrase at step 1504 of the method of FIG. 15 may include determining a phrase that was entered by a user in a search query and that subsequently led the user to perform an action that contributed to the particular event For instance, the second phrase “LED Safety Collar for Dogs” may be determined based on consumers entering the phrase into the search engine Google™, which led the consumer to Merchant Fred's product webpage 700 shown in FIG. 8, In an example, since a particular percentage of consumers purchased the product after arriving on the product webpage as a result of their Google™ search, the phrase suggestion engine 302 determines that the phrase “LED Safety Collar for Dogs” is a second phrase.

In some embodiments, determining that the second phrase is an alternative to the first phrase at step 1506 of the method of FIG. 15 may include determining that the first phrase and the second phrase share one or more of the same words. For example, the first phrase, “Glow Collar for Dogs”, is the name of the product sold by Merchant Edward, as shown in FIGS. 6, 7, and 10. The second phrase “LED Safety Collar for Dogs”, associated with the product for sale by Merchant Fred on the webpage 700 of FIG. 8, can be determined to be an alternative to the first phrase by the phrase suggestion engine 302 because it shares the words “collar” and “dogs” with the first phrase.

In some embodiments, determining that the second phrase is an alternative to the first phrase at step 1506 of the method of FIG. 15 may also or instead include determining that the first product and the second product have the same classification. For instance, the “Glow Collar for Dogs” sold by Merchant Edward shown in FIG. 6 is classified under “pet”, “dog”, “collar”, and “safety” 504. As the product for sale on a webpage 700 of Merchant Fred's online store in FIG. 8 is also classified under “pet”, “dog”, “collar”, and “safety” 704, the phrase “LED Safety Collar for Dogs” may be considered an alternative to the phrase “Glow Collar for Dogs” by the phrase suggestion engine 302.

In some embodiments, the web content is received from the device, e.g. the merchant device 320 of FIG. 4. The merchant may enter the web content through the user interface 328 of merchant device 320. In some embodiments, the second phrase is transmitted to the device for display concurrently with the first phrase at step 1508 of the method of FIG. 15. For example, the product webpage for Merchant Edward's light-up dog collar may be generated by Merchant Edward using merchant device 320. The second phrase, for instance “LED Safety Collar for Dogs”, may be transmitted from the phrase suggestion engine 302 over network 310 to the merchant device 320. The second phrase may be displayed on display 329 of user interface 328 side-by-side with the first phrase “Glow Collar for Dogs” from Merchant Edward's online store, which is shown in the pop-up windows of FIGS. 7, 10, and 13.

In some embodiments, an indication may be received from the device to replace the first phrase with the second phrase. For instance, FIGS. 7, 10, and 13 present Merchant Edward with the second phrase “LED Safety Collar for Dogs” as an alternative to the first phrase “Glow Collar for Dogs” in his online store. FIG. 7 provides a pop-up box 600 that asks Merchant Edward to consider the second phrase instead. FIG. 10 provides the second phrase as an option for “Phrase A” to use in split testing of alternative phrases in pop-up box 900. FIG. 13 presents the second phrase as a suggested alternative to the title of Product 001 in the product catalog 1000 within pop-up window 1200.

In some embodiments, the particular event in step 1504 of FIG. 15 may be a first event. The method may include determining a first score for the second phrase based on the first event and/or based on a similarity between the second phrase and the first phrase. The method may further include determining a third phrase associated with a third product for which a second event has occurred, and then determining a second score for the third phrase based on the second event and/or based on the similarity between the third phrase and the first phrase. Then, the second phrase and the third phrase may be transmitted to the device along with (i) the first score and the second score, and/or (ii) an indication of which one of the second phrase and the third phrase is to be displayed as a first recommended alternative phrase. For instance, a first event may be a sales conversion rate and a second event may be a frequency of sharing a product-related web page on social media. The second phrase, “LED Safety Collar for Dogs”, may result in a conversion rate of 23% and have two terms in common with the first phrase of “Glow Collar for Dogs”, resulting in a first score of 43. A third phrase, “USB Rechargeable Light-Up Dog Collar”, may be shared by 7% of page viewers and have two words in common with the first phrase, resulting in a score of 30. The phrases “LED Safety Collar for Dogs” and “USB Rechargeable Light-Up Dog Collar” may be presented to Merchant Edward on merchant device 320 along with their respective scores. The phrase suggestion engine 302 may provide the merchant device 320 with the recommendation to use the phrase “LED Safety Collar for Dogs” based on the provided scores.

In some embodiments, the method of FIG. 15 may also include receiving, from the device, an indication that the second phrase and the third phrase are to be subject to split testing. In response, the method may include: generating a first webpage including the web content with the second phrase instead of the first phrase and generating a second webpage including the web content with the third phrase instead of the first phrase. The method may also include tracking the frequency at which a particular action occurs in relation to the first webpage and in relation to the second webpage and transmitting a message that indicates whether the second phrase or the third phrase is associated with the particular action occurring more frequently. For example, split testing may be performed on the first phrase “Glow Collar for Dogs” on Merchant Edward's product webpage, as shown in FIG. 10. If “Phrase A” is selected to be “LED Safety Collar for Dogs” and to be displayed at a rate of 60% and “Phrase B” is selected to be “USB Rechargeable Light-Up Dog Collar” to be displayed at a rate of 40% in pop-up box 900, a first product web page for the light-up dog collar will show the product title “LED Safety Collar for Dogs” and a second product webpage would show the product title as “USB Rechargeable Light-Up Dog Collar”. The phrase suggestion engine 302 may collect data that, for example, determines that the use of the second phrase results in a sales conversion rate of 18% and the use of the third phrase results in a sales conversion rate of 15%, and provide this information to Merchant Edward on the display 329 of his merchant device 320.

In some embodiments, the order of steps 1504 and 1506 may be reversed. For instance, in one example a library of phrases (such as that shown in FIG. 9) could be established and maintained (e.g. in non-real time) in which each phrase in the library is associated with a respective product(s) for which a particular event has occurred. Then, when a merchant is entering a product description phrase, the system returns (e.g. in real-time) alternative phrases that are present in the library. This is an example in which step 1504 is performed before step 1506. Alternatively, in a different example, alternative phrases may first be determined without regard to whether or not the phrases are associated with a product for which a particular event has occurred, and then those alternative phrases are further filtered to only surface the ones that are associated with a product for which a particular event has occurred. This is an example in which step 1506 is performed before step 1504.

### Conclusion

Although the present invention has been described with reference to specific features and embodiments thereof, various modifications and combinations may be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions, and alterations may be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor-readable storage medium or media for storage of information, such as computer/processor-readable instructions, data structures, program modules, and/or other data. A non-exhaustive list of examples of non-transitory computer/processor-readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor-readable storage media.

The expression “at least one of A or B”, as used herein, is interchangeable with the expression “A and/or B”. It refers to a list in which you may select A or B or both A and B. Similarly, “at least one of A, B, or C” is alternatively expressed as “A and/or B and/or C” or “A, B, and/or C”. It refers to a list in which you may select A or B or C or both A and B or both A and C or both B and C or all of A, B and C. The same principle applies for longer lists having a same format.

1. A computer-implemented method comprising:
obtaining web content for a webpage, the web content comprising a first phrase describing a first product;
identifying a second phrase that has an association with a second product for which a particular event has occurred;
determining that the second phrase is an alternative the first phrase; and
transmitting the second phrase for display on a device.

2. The computer-implemented method of claim 1, wherein the particular event is that a sales conversion rate of the second product is above a particular threshold.

3. The computer-implemented method of claim 1, wherein determining the second phrase comprises determining a phrase used in a webpage that describes the second product.

4. The computer-implemented method of claim 1, wherein determining the second phrase comprises determining a phrase that was entered by a user in a search query and that subsequently led to the user performing an action that contributed to the particular event.

5. The computer-implemented method of claim 1, wherein determining that the second phrase is an alternative to the first phrase comprises: determining that the first phrase and the second phrase share one or more same words.

6. The computer-implemented method of claim 5, wherein determining that the second phrase is an alternative to the first phrase further comprises also determining that the first product and the second product have a same classification.

7. The computer-implemented method of claim 1, wherein the web content is received from the device, and wherein the second phrase is transmitted to the device for display concurrently with the first phrase.

8. The computer-implemented method of claim 7, further comprising receiving, from the device, an indication to replace the first phrase with the second phrase in the web content.

9. The computer-implemented method of claim 7, wherein the particular event is a first event, and wherein the method further comprises:
determining a first score for the second phrase based on at least one of the first event or a similarity between the second phrase and the first phrase;
determining a third phrase having an association with a third product for which a second event has occurred;
determining a second score for the third phrase based on at least one of the second event or the similarity between the third phrase and the first phrase; and
transmitting, to the device, the second phrase and the third phrase, along with at least one of (i) the first score and the second score, or (ii) an indication of which one of the second phrase and the third phrase is to be displayed as a first recommended alternative phrase.

10. The computer-implemented method of claim 9, further comprising:
receiving, from the device, an indication that the second phrase and the third phrase are to be subject to split testing; and
responsive to receiving the indication that the second phrase and the third phrase are to be subject to split testing:
generating a first webpage including the web content with the second phrase instead of the first phrase,
generating a second webpage including the web content with the third phrase instead of the first phrase,
tracking frequency at which a particular action occurs in relation to the first webpage and in relation to the second -webpage, and
transmitting a message that indicates whether the second phrase or the third phrase is associated with the particular action occurring more frequently.

11. A system comprising:
a memory to store a webpage;
at least one processor to:
obtain web content for the webpage, the web content comprising a first phrase describing a first product;
identify a second phrase that has an association with a second product for which a particular event has occurred;
determine that the second phrase is an alternative to the first phrase; and
instruct transmission of the second phrase to a device for display on the device.

12. The system of claim 11, wherein the particular event is that a sales conversion rate of the second product is above a particular threshold.

13. The system of claim 11, wherein the at least one processor is to determine the second phrase by performing operations comprising: determining a phrase used in a webpage that describes the second product.

14. The system of claim 11, wherein the at least one processor is to determine the second phrase by performing operations comprising: determining a phrase that was entered by a user in a search query and that subsequently led to the user performing an action that contributed to the particular event.

15. The system of claim 11, wherein the at least one processor is to determine that the second phrase is an alternative to the first phrase by performing operations comprising: determining that the first phrase and the second phrase share one or more same words.

16. The system of claim 15, wherein the at least one processor is to determine that the second phrase is an alternative to the first phrase further by performing further operations comprising: determining that the first product and the second product have a same classification.

17. The system of claim 11, wherein the web content originates from the device, and wherein the at least one processor is to: instruct transmission of the second phrase to the device for display concurrently with the first phrase.

18. The system of claim 17, wherein the at least one processor is to receive an indication to replace the first phrase with the second phrase in the web content, wherein the indication originates from the device.

19. The system of claim 17, wherein the particular event is a first event, and wherein the at least one processor is further to:
determine a first score for the second phrase based on at least one of the first event or a similarity between the second phrase and the first phrase;
determine a third phrase having an association with a third product for w a second event has occurred;
determine a second score for the third phrase based on at least one of the second event or the similarity between the third phrase and the first phrase; and
instruct transmission, to the device for display on the device, the second phrase and the third phrase, along with at least one of: (i) the first score and the second score, or (ii) an indication of which one of the second phrase and the third phrase to display as a first recommended alternative phrase.

20. The system of claim 19, wherein the at least one processor is to receive an indication that the second phrase and the third phrase are to be subject to split testing, and responsive to receiving the indication that the second phrase and the third phrase are to be subject to split testing, the at least one processor is further to:
generate a first webpage including the web content with the second phrase instead of the first phrase,
generate a second webpage including the web content with the third phrase instead of the first phrase,
track a frequency at which a particular action occurs in relation to the first webpage and in relation to the second webpage, and
instruct transmission, to the device for display of the device, a message that indicates whether the second phrase or the third phrase is associated with the particular action occurring more frequently.

21. A computer-readable medium having stored thereon computer-executable instructions that, when executed, cause a computer to perform operations comprising:
obtaining web content for a webpage, the web content comprising a first phrase describing a first product;
identifying a second phrase that has an association with a second product for which a particular event has occurred;
determining that the second phrase is an alternative to the first phrase; and
transmitting the second phrase for display.
